(19) United States
(12) Patent Application Publication
(10) Pub. No.: US 2015/0037746 A1
(43) Pub. Date: Feb. 5, 2015

(54) HEAT CONDUCTION DEVICE INCLUDED CRUCIBLE

(71) Applicant: Shenzhen China Star Optoelectronics Technology Co., Ltd., Shenzhen, Guangdong (CN)

(72) Inventor: Qinghua Zou, Shenzhen City (CN)

(73) Assignee: Shenzhen China Star Optoelectronics Technology Co., Ltd., Shenzhen, Guangdong (CN)

(21) Appl. No.: 14/003,455

(22) PCT Filed: Aug. 7, 2013
(86) PCT No.: PCT/CN2013/080938

§ 371 Date: Sep. 6, 2013

(30) Foreign Application Priority Data
Aug. 2, 2013 (CN) 201310335428.7

(51) Int. Cl. F27B 14/08

(52) U.S. Cl. CPC F27B 14/08; F27B 2014/0843
USPC 432/265

(57) ABSTRACT

The present invention provides a heat conduction device included crucible, which includes: a crucible body and a heat conduction device arranged in the crucible body. The heat conduction device has a tree-like configuration, which includes a heat-dissipative trunk and multiple levels of heat dissipative branches mounted to the heat-dissipative trunk. Each level of the heat dissipative branches includes a plurality of branch units and the branch units are arranged to project out from an outer surface of the heat-dissipative trunk. The heat conduction device included crucible of the present invention uses the tree-like heat conduction device arranged in the crucible body to transfer heat in every direction within the crucible body so that during a vapor deposition operation, an organic material received in the crucible body can be heated uniformly thereby avoiding the phenomenon of partial decomposition of the organic material occurring in the prior art technique due to non-uniform heating of the organic material and thus effectively improving the vapor deposition efficiency and vapor deposition performance.

### BACKGROUND OF THE INVENTION

1. Field of the Invention

The present invention relates to the field of manufacture of display devices, and in particular to a heat conduction included crucible for vapor deposition performed with an organic material coater.

2. The Related Arts

A flat panel display has a variety of advantages, such as thin device body, low power consumption, and being free of radiation, and is widely used. Flat panel displays that are currently available generally include liquid crystal displays (LCDs) and organic light emitting displays (OLEDs).

The LCDs that are currently available in the market are generally backlighting LCDs, which comprise an enclosure, a liquid crystal display panel arranged in the enclosure, and a backlight module arranged in the enclosure. The operation principle of the liquid crystal display panel is that liquid crystal molecules are arranged between two parallel glass substrates and a drive voltage is selectively applied to the two glass substrates to control rotation of the liquid crystal molecules in order to refract out light emitting from the backlight module for generating images.

Referring to FIG. 1, a conventional liquid crystal display panel generally comprises: a thin-film transistor (TFT) substrate 302, a color filter (CF) substrate 304 that is opposite to and bonded to the TFT substrate 302, and a liquid crystal layer 306 interposed between the TFT substrate 302 and the CF substrate 304. The TFT substrate 302 drives the liquid crystal molecules contained in the liquid crystal layer 306 to rotate so as to display a corresponding image.

The OLEDs, which show the characteristics of self-illumination, high brightness, wide view angle, high contrast, flexibility, and low energy consumption, attract wide attention for serving as the next-generation display measures and gradually substitute the conventional LCDs for wide application in various fields including mobile phone screens, computer monitors, and full-color television. The OLEDs are different from the conventional LCDs in that they need no backlight and extremely thin coating layers of organic materials are directly formed on the glass substrates so that when electrical currents flow therethrough, the organic material coating layers emit light.

The currently available OLEDs are classified according to the driving methods used and include a passive matrix organic light emitting diode (PMOLED) and an active matrix organic light emitting diode (AMOLED). As shown in FIG. 2, the AMOLED generally comprises a substrate 502, a TFT 504 formed on the substrate 502, and an organic light-emitting diode 506 formed on the TFT 504. The TFT 504 drives the organic light-emitting diode 506 to give off light in order to display a corresponding image.

According to the molecular weight of the organic light-emitting material used, the OLEDs can be classified as a small molecule organic light-emitting display (OLED) and a polymer light-emitting display (PLED). Due to the difference of molecular weight, the manufacturing processes of the OLEDs are substantially different. The OLED is generally manufactured through vapor deposition, while the PLED is manufactured through spin coating or ink jet printing.

Vapor deposition is carried out by using OLED vapor deposition equipment to heat an organic material in a vacuum environment (E-5 Pa) to have sublimation type or melting type organic material to get vaporized and deposited on a substrate on which a TFT structure or an anode structure is formed. The mainstream evaporation sources are generally a point evaporation source and a line evaporation source. The point evaporation source is generally used in experiments and early production lines. The line evaporation source is superior to the point evaporation source in respect of material utilization and uniformity of film thickness, so that most of the late built product lines use the line evaporation source. However, the point evaporation source occupies a small amount of space so that a large number of point evaporation sources can be installed in a coating chamber and many types of materials can be filled therein, making it fit for a pilot production line.

The evaporation temperature and the decomposition temperature of an organic material do not differ much. A crucible of a point evaporation source often has a great difference in the interior thereof (top side hot and bottom side cold). If an excessive amount of material is filled therein, it is generally not possible for the material to reach a steady state of thermal balance so that the evaporation rate cannot maintain stable; and temperature rise may cause inhomogeneous heating of the material, often leading to the potential risk of decomposition of the material on the top side. If the material filled is of a reduced amount, in case of high evaporation rate, the temperature in the top side of the crucible may get beyond the decomposition temperature of the material so that the vaporized material may get decomposed when passing through this zone.

To overcome such a problem, heretofore, heat conduction beads are used. In filling an organic material in a crucible, the heat conduction beads are also mixed therein, so that through heat conduction effected through the heat conduction beads, the temperature is made homogeneous in the material. This method, however, is only well effective for sublimation type materials. The melting type material get molten in a high temperature and the heat conduction beads have a density different from the organic material, so that the heat conduction beads will gradually settle down on the bottom of the crucible, making it no longer effective to transfer heat.

### SUMMARY OF THE INVENTION

An object of the present invention is to provide a heat conduction device included crucible, which has an excellent effect of heat conduction and can stably vaporize an organic material, reduce the potential risk of decomposition of the organic material, so as to improve the effectiveness of vapor deposition.

To achieve the object, the present invention provides a heat conduction device included crucible, which comprises: a crucible body and a heat conduction device arranged in the crucible body. The heat conduction device has a tree-like configuration, which comprises a heat-dissipative trunk and multiple levels of heat dissipative branches mounted to the heat-dissipative trunk. Each level of the heat dissipative branches comprises a plurality of branch units. The branch units are arranged to project out from an outer surface of the heat-dissipative trunk.

The heat-dissipative trunk comprises a cylindrical heat dissipative bar, which is substantially parallel to a main axis of the crucible body.

The heat dissipative branches are normal to the heat-dissipative trunk.

The heat dissipative branches extend from an outer surface of the heat-dissipative trunk in an upward inclined manner.

The heat dissipative branches extend from an outer surface of the heat-dissipative trunk in a downward inclined manner.

The heat-dissipative trunk comprises at least two cylindrical heat dissipative bars. The heat dissipative bars are connected together by a plurality of connection rods and are substantially parallel to a main axis of the crucible body.

The branch units each comprise a plurality of twigs and the twigs are arranged to extend out from an outer surface of the branch unit.

The branch unit and the twigs are integrally formed of a metal material or are separately made of metal materials and then jointed through welding.

The heat conduction device is integrally formed of a metal material.

The heat-dissipative trunk and the heat dissipative branches are separately made of metal materials and then jointed through welding.

The present invention provides a heat conduction device included crucible, which comprises: a crucible body and a heat conduction device arranged in the crucible body, the heat conduction device having a tree-like configuration, which comprises a heat-dissipative trunk and multiple levels of heat dissipative branches mounted to the heat-dissipative trunk, each level of the heat dissipative branches comprising a plurality of branch units, the branch units being arranged to project out from an outer surface of the heat-dissipative trunk;
wherein the heat-dissipative trunk comprises a cylindrical heat dissipative bar, which is substantially parallel to a main axis of the crucible body.

The heat dissipative branches are normal to the heat-dissipative trunk.

The heat dissipative branches extend from an outer surface of the heat-dissipative trunk in an upward inclined manner.

The heat dissipative branches extend from an outer surface of the heat-dissipative trunk in a downward inclined manner.

The heat conduction device is integrally formed of a metal material.

The heat-dissipative trunk and the heat dissipative branches are separately made of metal materials and then jointed through welding.

The efficacy of the present invention is that the present invention provides a heat conduction device included crucible, which is used in a coater for vapor deposition of an organic material of an organic light-emitting diode, wherein through an arrangement of a tree-like heat conduction device in the crucible body to transfer heat in every direction within the crucible body so that during a vapor deposition operation, an organic material received in the crucible body can be heated uniformly thereby avoiding the phenomenon of partial decomposition of the organic material occurring in the prior art technique due to non-uniform heating of the organic material and thus effectively improving the vapor deposition efficiency and vapor deposition performance.

For better understanding of the features and technical contents of the present invention, reference will be made to the following detailed description of the present invention and the attached drawings. However, the drawings are provided for the purposes of reference and illustration and are not intended to impose undue limitations to the present invention.

### BRIEF DESCRIPTION OF THE DRAWINGS

The technical solution, as well as other beneficial advantages, of the present invention will be apparent from the following detailed description of an embodiment of the present invention, with reference to the attached drawings. In the drawings:

FIG. 1 is a schematic view showing the structure of a conventional liquid crystal display panel;

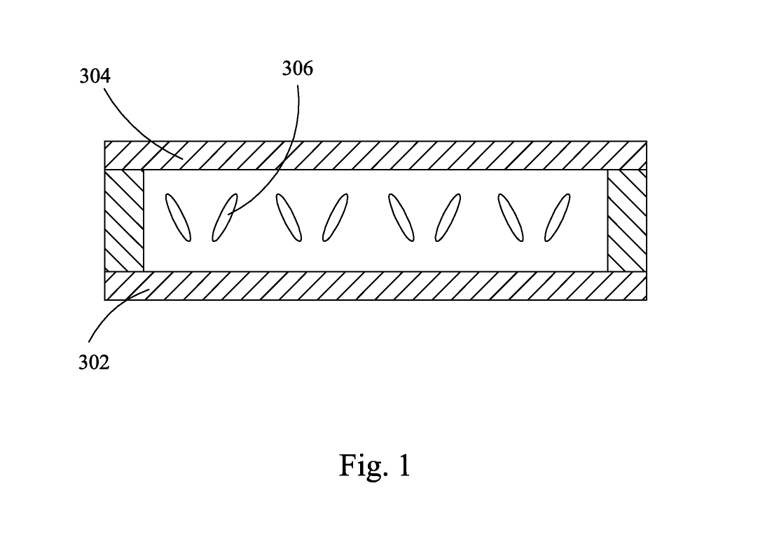

FIG. 2 is a schematic view showing the structure of a conventional organic light emitting display panel;

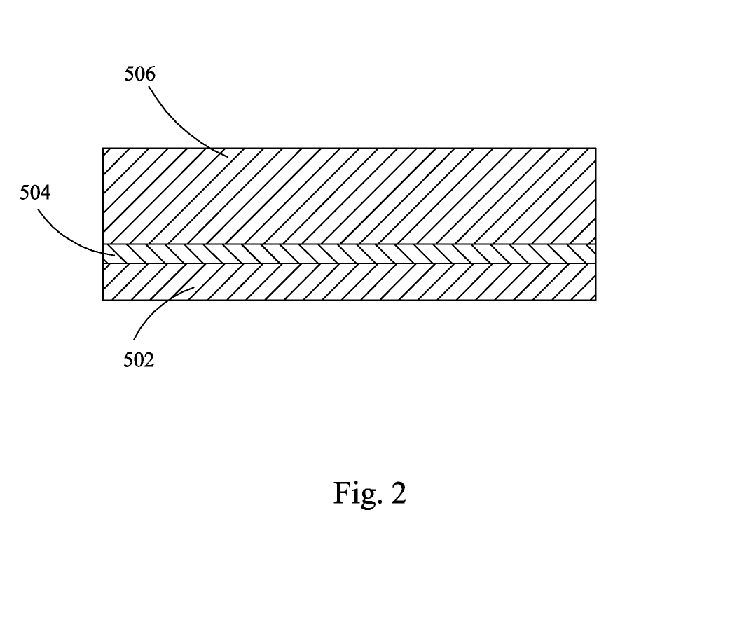

FIG. 3 is a schematic cross-sectional view illustrating a heat conduction device included crucible according to a first embodiment of the present invention;

FIG. 4 is a top plan view of the heat conduction device included crucible according to the first embodiment of the present invention;

FIG. 5 is a schematic cross-sectional view illustrating a heat conduction device included crucible according to a second embodiment of the present invention;

FIG. 6 is a schematic cross-sectional view illustrating a heat conduction device included crucible according to a third embodiment of the present invention;

FIG. 7 is a schematic cross-sectional view illustrating a heat conduction device included crucible according to a fourth embodiment of the present invention; and

FIG. 8 is a top plan view illustrating a heat conduction device included crucible according to a fifth embodiment of the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

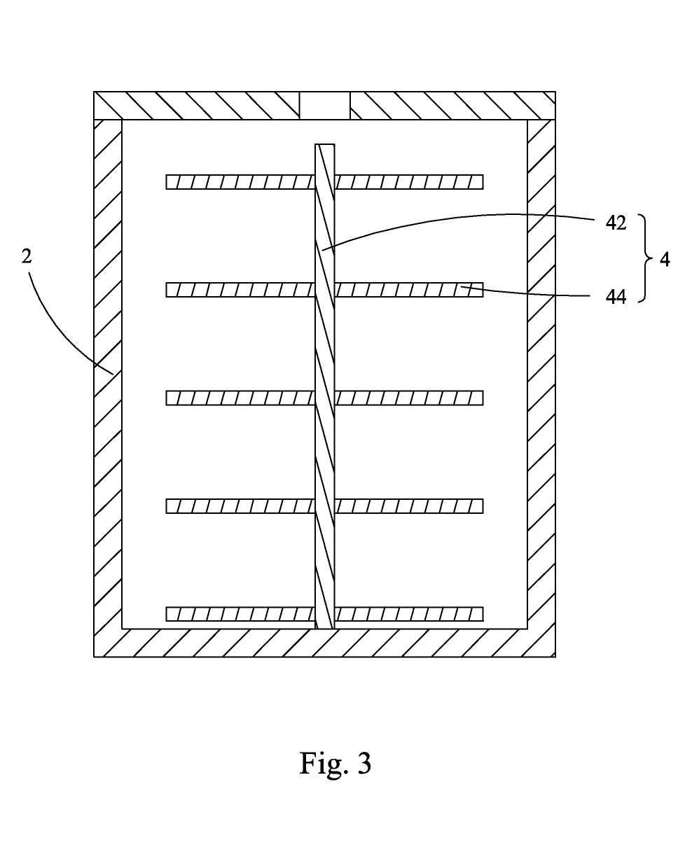

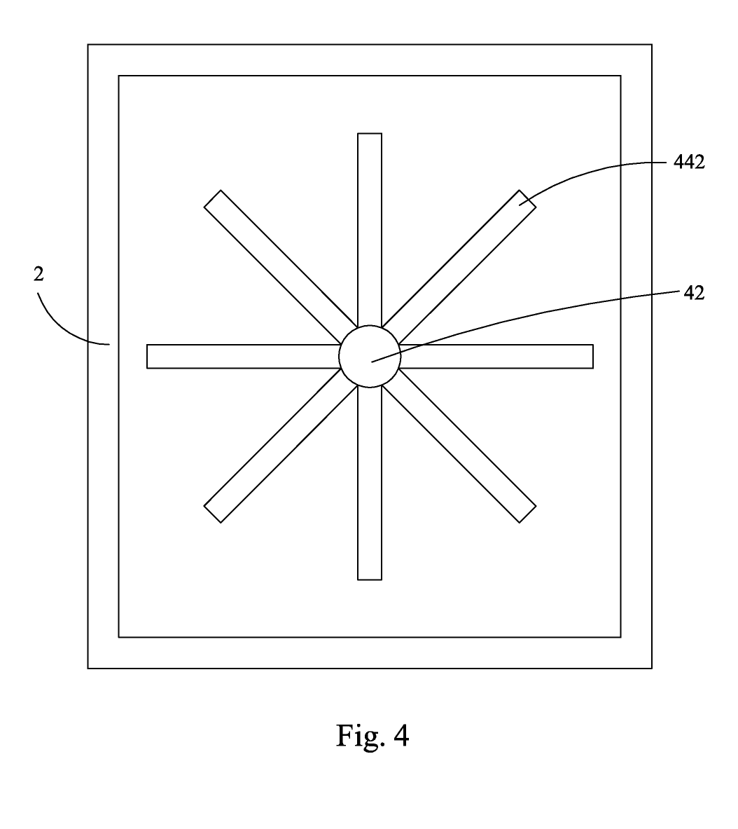

Referring to FIGS. 3 and 4, the present invention provides a heat conduction device included crucible, which is used in a coater for vapor deposition of an organic material of an organic light-emitting diode and comprises: a crucible body 2 and a heat conduction device 4 arranged in the crucible body 2. The heat conduction device 4 is of a tree-like configuration, which comprises a heat-dissipative trunk 42 and multiple levels 44 of heat dissipative branches mounted to the heat-dissipative trunk 42. Each level 44 of heat dissipative branches comprises a plurality of branch units 442 and the branch units 442 are arranged to project out from an outer surface of the heat-dissipative trunk 42. The present invention uses the tree-like heat conduction device 4 to transfer heat in every direction inside the crucible body 2 so as to have an organic material (not shown) placed in the crucible body 2 uniformly heated during vapor deposition thereby avoiding the phenomenon of poor deposition result resulting from partial decomposition of the organic material caused by non-uniform heating of the organic material.

In the instant embodiment, the heat-dissipative trunk 42 is a cylindrical heat dissipative bar, which is substantially parallel to a main axis of the crucible body 2. The heat-dissipative trunk 42 can be exactly parallel to the main axis of the crucible body 2 or shows a minor angle inclination with respect thereto and a specific structure (length of the heat-dissipative trunk 42 and relative angle between the heat-dissipative trunk 42 and the main axis of the crucible body 2) that can be determined according to the actual size of the crucible body 2 and an actual temperature difference, all being effective in realizing the technical efficacy of the present invention.

It is noted that the heat conduction device 4 is integrally formed of a metal material that has excellent heat conductivity; or alternatively, the heat-dissipative trunk 42 and the heat dissipative branches 44 are separately made of metal materials having excellent heat conductivity and are jointed by welding. The heat conduction device 4 can be made rotatable with an external arrangement so that the organic material placed in the crucible body 2 can be stirred or change locations inside the crucible body 2 to facilitate uniform heating of the organic material inside the crucible body.

Referring to FIGS. 3 and 4, in the instant embodiment, the branch units 442 are normal to the heat-dissipative trunk 42. The branch units 442 of each level of heat dissipative branches 44 are substantially evenly distributed along an outer circumference of the heat-dissipative trunk 42.

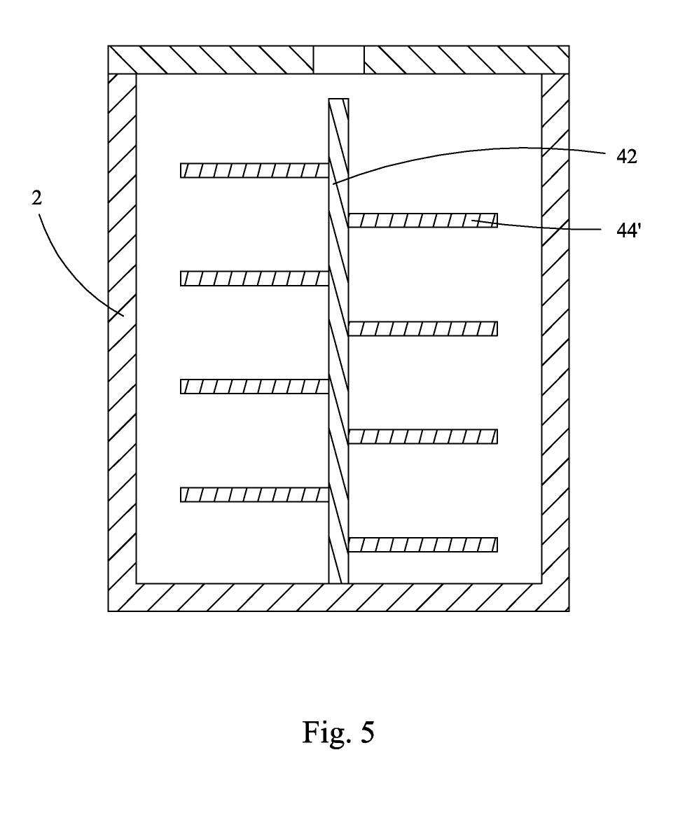

Referring to FIG. 5, which is a schematic view showing the structure of a second embodiment of the present invention, in the instant embodiment, two adjacent ones of the heat dissipative branches 44′ are respectively set at opposite sides of the heat-dissipative trunk 42. In other words, the heat dissipative branches 44′ are arranged to alternately mount to opposite sides of the heat-dissipative trunk 42. This can similarly achieve the same technical efficacy of the present invention.

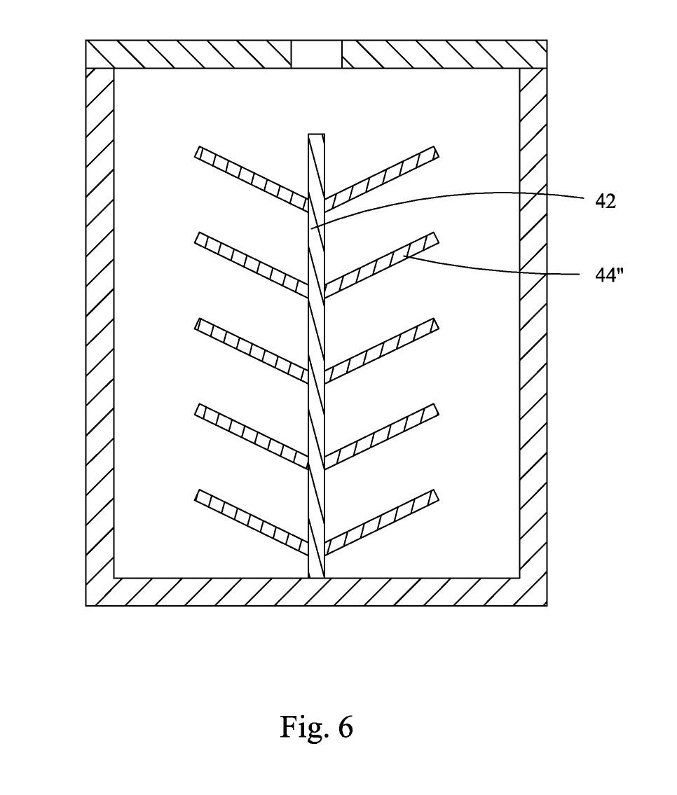

Referring to FIG. 6, which is a schematic view showing the structure of a third embodiment of the present invention, in the instant embodiment, the heat dissipative branches 44″ are set to extend from an outer surface of the heat-dissipative trunk 42 in an upward inclined manner. This can similarly achieve the same technical efficacy of the present invention.

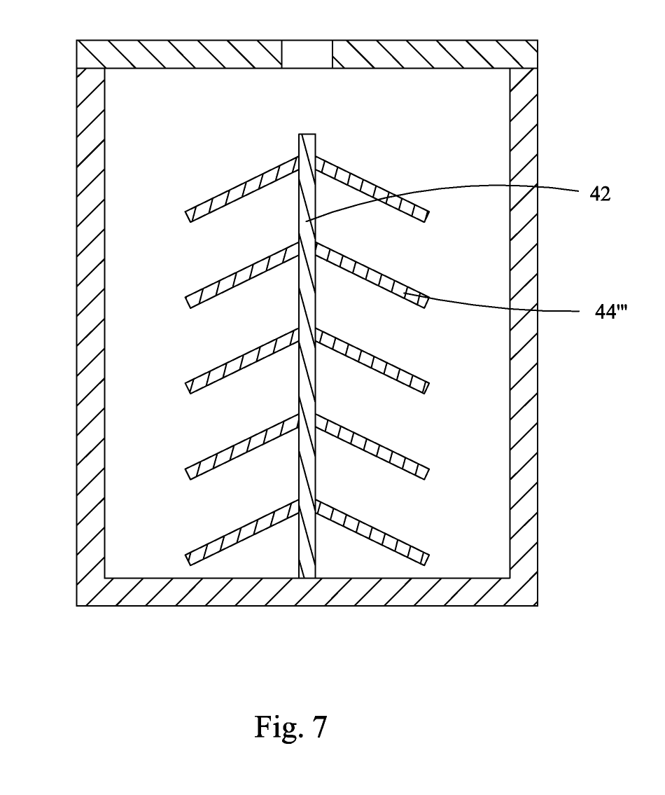

Referring to FIG. 7, which is a schematic view showing the structure of a fourth embodiment of the present invention, in the instant embodiment, the heat dissipative branches 44′″ are set to extend from an outer surface of the heat-dissipative trunk 42 in a downward inclined manner. This can similarly achieve the same technical efficacy of the present invention.

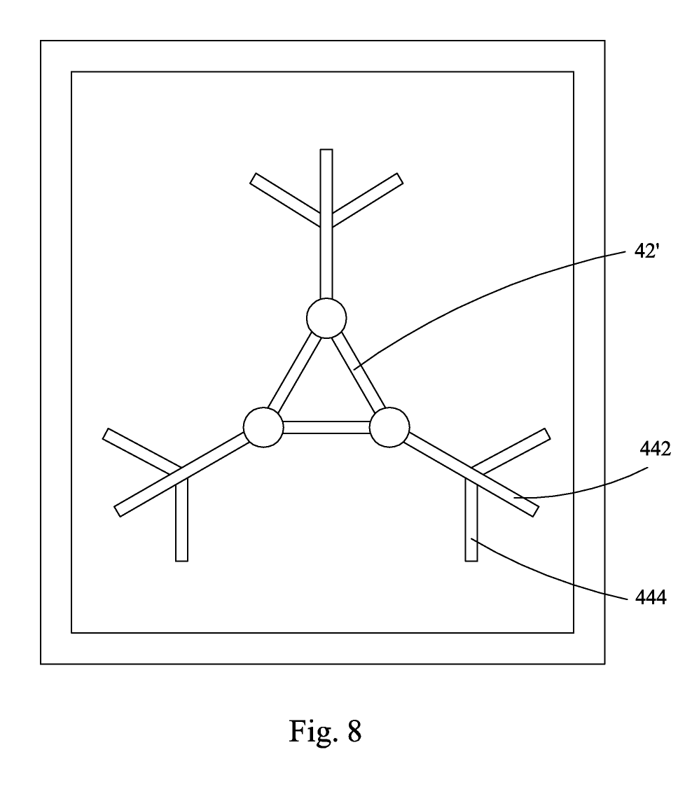

Referring to FIG. 8, which is a schematic view showing the structure of a fifth embodiment of the present invention, in the instant embodiment, the heat-dissipative trunk 42′ comprises at least two cylindrical heat-dissipative bars. These bars are connected together by a plurality of connection rods and are parallel to or slightly inclined with respect to a main axis of the crucible body. The heat-dissipative bars and the connection rods are made of a metal material having excellent heat conductivity or are made separately of metal materials having excellent conductivity and then jointed through measures such as welding.

The branch units 442 may each comprise a plurality of twigs 444. The twigs 444 are arranged to extend from an outer surface of the branch unit 442. In the instant embodiment, the branch unit 442 and the twigs 444 are integrally formed of a metal material having excellent heat conductivity or can separately made of metal materials having excellent heat conductivity and then jointed by measures such as welding. Compared to the above described embodiments, the instant embodiment provides better effect of heat conduction but the structure is relatively complicated, making it high of the cost.

In summary, the present invention provides a heat conduction device included crucible, which is used in a coater for vapor deposition of an organic material of an organic light-emitting diode, wherein through an arrangement of a tree-like heat conduction device in the crucible body to transfer heat in every direction within the crucible body so that during a vapor deposition operation, an organic material received in the crucible body can be heated uniformly thereby avoiding the phenomenon of partial decomposition of the organic material occurring in the prior art technique due to non-uniform heating of the organic material and thus effectively improving the vapor deposition efficiency and vapor deposition performance.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A heat conduction device included crucible, comprising: a crucible body and a heat conduction device arranged in the crucible body, the heat conduction device having a tree-like configuration, which comprises a heat-dissipative trunk and multiple levels of heat dissipative branches mounted to the heat-dissipative trunk, each level of the heat dissipative branches comprising a plurality of branch units, the branch units being arranged to project out from an outer surface of the heat-dissipative trunk.

2. The heat conduction device included crucible as claimed in claim 1, wherein the heat-dissipative trunk comprises a cylindrical heat dissipative bar, which is substantially parallel to a main axis of the crucible body.

3. The heat conduction device included crucible as claimed in claim 2, wherein the heat dissipative branches are normal to the heat-dissipative trunk.

4. The heat conduction device included crucible as claimed in claim 2, wherein the heat dissipative branches extend from an outer surface of the heat-dissipative trunk in an upward inclined manner.

5. The heat conduction device included crucible as claimed in claim 2, wherein the heat dissipative branches extend from an outer surface of the heat-dissipative trunk in a downward inclined manner.

6. The heat conduction device included crucible as claimed in claim 1, wherein the heat-dissipative trunk comprises at least two cylindrical heat dissipative bars, the heat dissipative bars being connected together by a plurality of connection rods and being substantially parallel to a main axis of the crucible body.

7. The heat conduction device included crucible as claimed in claim 6, wherein the branch units each comprise a plurality of twigs, the twigs being arranged to extend out from an outer surface of the branch unit.

8. The heat conduction device included crucible as claimed in claim 7, wherein the branch unit and the twigs are integrally formed of a metal material or are separately made of metal materials and then jointed through welding.

9. The heat conduction device included crucible as claimed in claim 1, wherein the heat conduction device is integrally formed of a metal material.

10. The heat conduction device included crucible as claimed in claim 1, wherein the heat-dissipative trunk and the heat dissipative branches are separately made of metal materials and then jointed through welding.

11. A heat conduction device included crucible, comprising: a crucible body and a heat conduction device arranged in the crucible body, the heat conduction device having a tree-like configuration, which comprises a heat-dissipative trunk and multiple levels of heat dissipative branches mounted to the heat-dissipative trunk, each level of the heat dissipative branches comprising a plurality of branch units, the branch units being arranged to project out from an outer surface of the heat-dissipative trunk;
wherein the heat-dissipative trunk comprises a cylindrical heat dissipative bar, which is substantially parallel to a main axis of the crucible body.

12. The heat conduction device included crucible as claimed in claim 11, wherein the heat dissipative branches are normal to the heat-dissipative trunk.

13. The heat conduction device included crucible as claimed in claim 11, wherein the heat dissipative branches extend from an outer surface of the heat-dissipative trunk in an upward inclined manner.

14. The heat conduction device included crucible as claimed in claim 11, wherein the heat dissipative branches extend from an outer surface of the heat-dissipative trunk in a downward inclined manner.

15. The heat conduction device included crucible as claimed in claim 11, wherein the heat conduction device is integrally formed of a metal material.

16. The heat conduction device included crucible as claimed in claim 11, wherein the heat-dissipative trunk and the heat dissipative branches are separately made of metal materials and then jointed through welding.
